(19) United States
(12) Patent Application Publication
(10) Pub. No.: US 2004/0058114 A1
(43) Pub. Date: Mar. 25, 2004

(54) Compact disk label apparatus and storage sleeve

(76) Inventor: Richard C. Koch, Rancho Santa Margarita, CA (US)

Correspondence Address: Kenneth W. Float, The Law Offices of Kenneth W. Float, P. O. Box 80790, Rancho Santa Margarita, CA, 92688, US

(21) Appl. No.: 10/253,327

(22) Filed: Sep. 24, 2002

(51) Int. Cl. B65D 85/57; B29C 53/36; B29C 53/00; B65D 85/30; B32B 9/00

(52) U.S. Cl. 428/40.1; 156/217; 156/277; 206/308.1

(57) ABSTRACT

Compact disk label apparatus that allows printing of a compact disk label and that is configurable as a compact disk sleeve, and method of making the sleeve. The apparatus comprises a backing or carrier layer and an adhesively-backed label layer. The label layer comprises one or more adhesive-backed compact disk labels. The compact disk labels may be printed on and may be peeled and removed from contact with the backing or carrier layer. The backing or carrier layer is slit or cut adjacent a plurality of its edges to allow them to be removed from contact with the adhesive-backed label layer. A perforation or fold is formed across the compact disk label apparatus that allows the compact disk label apparatus to be folded onto itself to seal its edges using the exposed adhesive surfaces of the adhesive-backed label layer to form a sleeve that has an open end. An optional folding tab portion may be provided that may be folded over the open end of the compact disk sleeve.

### BACKGROUND

The present invention relates generally to compact disk label apparatus for use with a compact disk that may also be configured as a compact disk sleeve and method of making same.

Compact disk sleeves are used to encase many compact disks when they are sold. In addition, compact disk sleeves have been sold in boxed form containing twenty or fifty sleeves in a box. It would be desirable and provide a cost savings to the consumer to have a disk label that may be converted into a compact disk sleeve once the disk label is made.

The present inventor believes that some type of compact disk label sleeve known as “Rappit” is manufactured by Continental Data Labels, but details of this produce are not presently known. Also, Fellowes, Inc. manufactures a compact disk label sleeve. Multiple tears are required and this product must be folded multiple times to form the sleeve and a removable label is not provided.

It is an objective of the present invention to provide for compact disk label apparatus for use with a compact disk that may be configured as a compact disk sleeve. It is also an objective of the present invention to provide for a method of making a compact disk sleeve.

### SUMMARY OF THE INVENTION

To accomplish the above and other objectives, the present invention provides for improved compact disk label apparatus for use with a compact disk that allows printing of a compact disk label and that is also configurable as a compact disk sleeve. A method of making the compact disk sleeve is also disclosed.

The compact disk label apparatus comprises a backing or carrier layer having a front surface onto which a label layer is disposed. The label layer has adhesive disposed thereon which adheres it to the backing or carrier layer.

The label layer comprises one or more adhesive-backed compact disk labels, which may be formed such as by cutting or slitting the label layer. The compact disk labels may be printed on and may be peeled and removed from contact with the backing or carrier layer. The backing or carrier layer is slit or cut adjacent to certain of its edges to allow the edges to be peeled from and removed from contact with the adhesive-backed label layer.

A perforation or fold is formed across the compact disk label apparatus. The perforation or fold allows the compact disk label apparatus to be folded onto itself to seal a plurality of its edges using the exposed adhesive surfaces of the adhesive-backed label layer. This sealing operation forms a sleeve that has an open end. An optional folding tab portion may be provided that may be folded over the open end of the compact disk sleeve. Punched holes may be provided to permit the compact disk sleeve 35 to be stored in a ring-type binder.

Only a single folding operation is required to form the compact disk sleeve. Also, no additional tearing operations are necessary, which is required with the Fellowes, Inc. sleeve. This is a significant improvement over the Fellowes, Inc. compact disk sleeve.

In accordance with one exemplary method, the above-described compact disk label apparatus is provided. Software is used to print onto a compact disk label of the compact disk label apparatus. The compact disk label is then removed (peeled away) from contact with the backing or carrier layer and attached to a compact disk. A plurality of the edges of the backing or carrier layer are peeled or removed to expose the adhesive on the edges of the label layer. The compact disk label apparatus is then folded along the perforation or fold so that it folds onto itself allowing the adhesive edges to adhere to itself or to the backing or carrier layer if a portion of the backing or carrier layer was removed. This forms the sleeve with an open end into which the labeled compact disk may be placed.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 illustrates an exploded view of an exemplary embodiment of compact disk labeling apparatus in accordance with the principles of the present invention that is configurable as a compact disk sleeve;

FIG. 2 illustrates a front view of the exemplary compact disk labeling apparatus;

FIG. 3 illustrates a rear view of the exemplary compact disk labeling apparatus;

FIGS. 4a-4c illustrate formation of the compact disk sleeve;

FIG. 5 is a flow diagram that illustrates an exemplary method in accordance with the principles of the present invention of making a compact disk sleeve; and

FIGS. 6 and 7 show alternative embodiments of the compact disk labeling apparatus.

### DETAILED DESCRIPTION

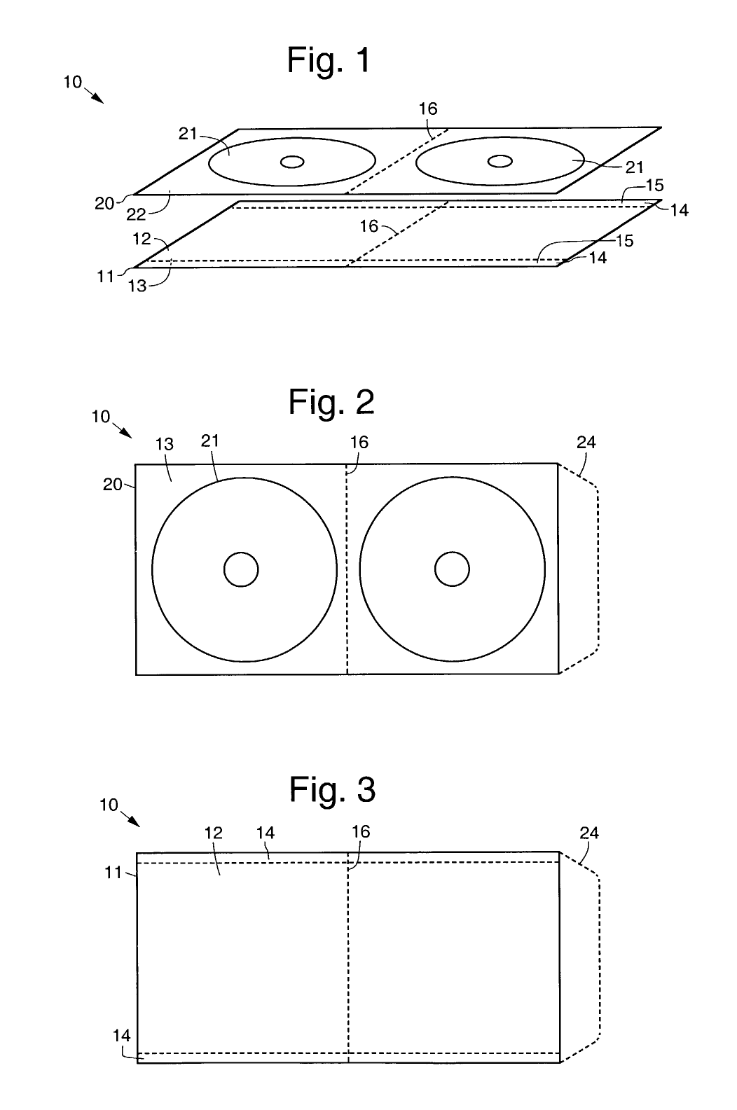

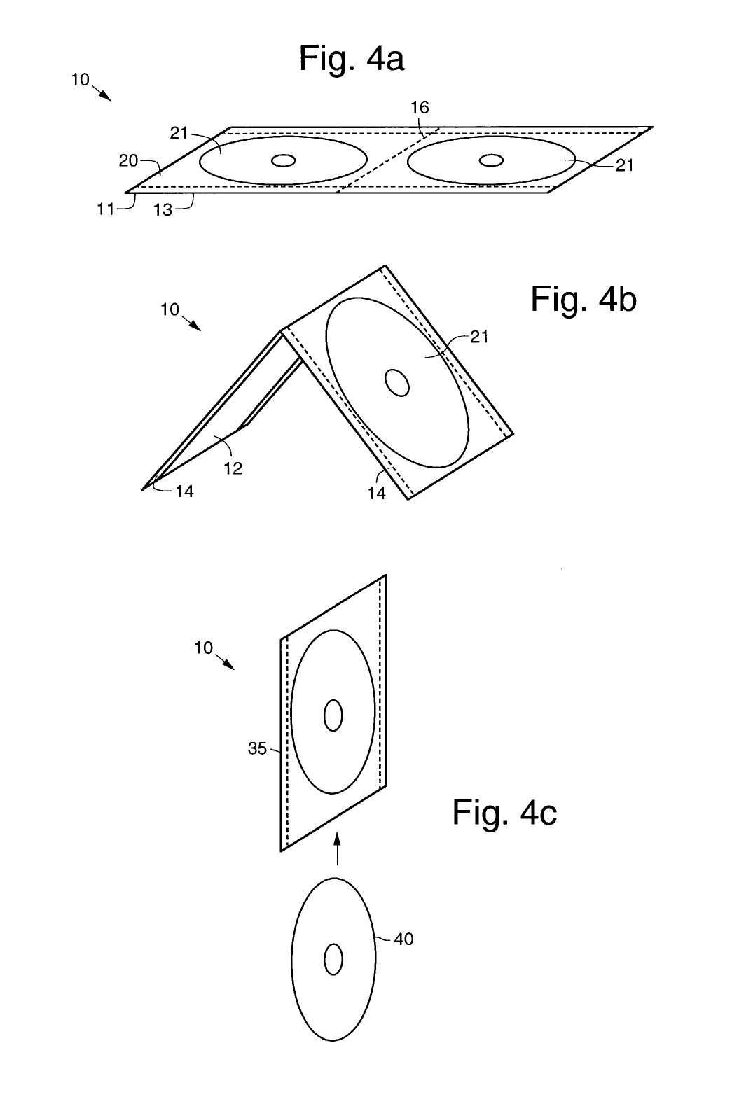

Referring to the drawing figures, FIG. 1 illustrates n exploded view of an exemplary embodiment of compact disk labeling apparatus 10 in accordance with the principles of the present invention. FIG. 2 illustrates a front view of the exemplary compact disk labeling apparatus 10. FIG. 3 illustrates a rear view of the exemplary compact disk labeling apparatus 10. The compact disk label apparatus 10 may be used with a compact disk 40 (FIG. 4c) that allows printing of a compact disk label 21 and that is also configurable as a compact disk sleeve 35 (FIG. 4c).

The compact disk label apparatus 10 comprises a backing or carrier layer 11 and a label layer 20. The backing or carrier layer 11 is typically made from a wax-like paper that permits removal of an adhesively-backed paper label layer 20. The backing or carrier layer 11 has front and rear surfaces 12, 13. The label layer 20 has adhesive disposed a rear surface 22 thereof and is attached to the front surface 12 of the backing or carrier layer 11.

The label layer 20 comprises one or more adhesive-backed compact disk labels 21, formed such as by cutting or slitting the label layer 20. The one or more adhesive-backed compact disk labels 21 with central openings 22 may be printed on and may be peeled and removed from contact with the front surface 12 of the backing or carrier layer 11 by peeling the label 21 off of the backing or carrier layer 11.

The backing or carrier layer 11 is also slit or cut adjacent to a plurality of its edges 31 (lateral edges 31 are illustrated) to allow the edges 15 to be peeled from and removed from contact with the label layer 20. Alternatively, adjacent edges may also be slit or cut to allow removal of the backing or carrier layer 11 from contact with the label layer 20.

A perforation 16 or fold 16 is formed across the compact disk label apparatus 10 that allows it to be folded onto itself, to seal the edges 14 of the backing or carrier layer 11 and form the sleeve 35 having an open end. As is shown in FIGS. 2 and 3, an optional folding tab portion 24 may be provided that extends from the backing or carrier layer 11 that may be folded over the open end of the sleeve 35 to fully enclose it.

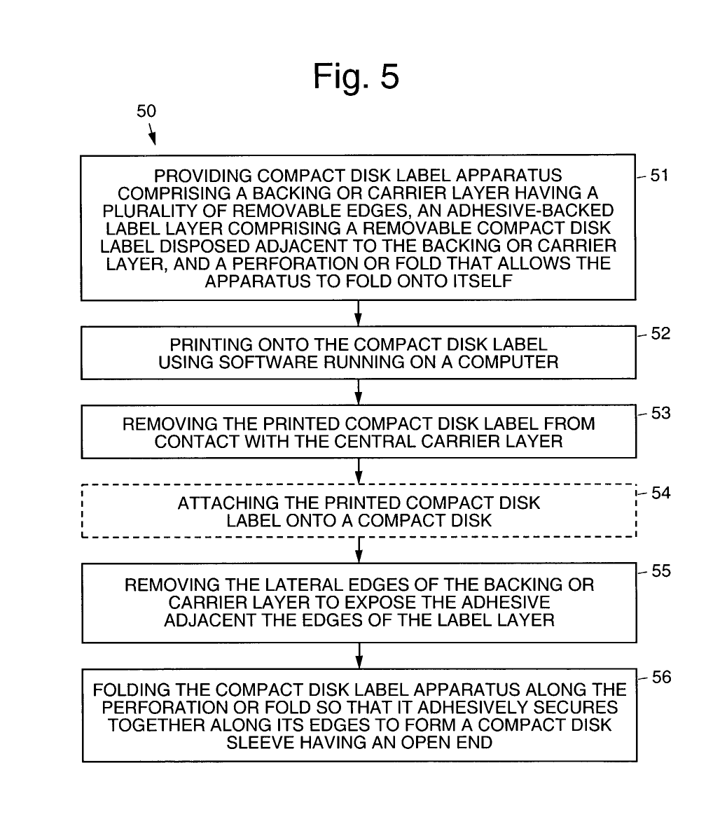

FIGS. 4a-4c illustrate formation of the compact disk sleeve 35. FIG. 5 is a flow diagram that illustrates an exemplary method 50 in accordance with the principles of the present invention of making the compact disk sleeve 35. The exemplary method 50 comprises the following steps, with reference also to FIGS. 4a-4c.

A compact disk label apparatus 10 is provided 51 that comprises a backing or carrier layer 11 that is slit or cut adjacent a plurality of its edges 31, an adhesive-backed label layer 20 comprising one or more removable adhesive-backed compact disk labels, and a perforation 16 that allows the apparatus 10 to be folded onto itself.

Software running on a computer is used to print 52 onto a compact disk label 21. The compact disk label 21 is then removed (peeled away) 53 from contact with the backing or carrier layer 11 and is optionally and preferably attached 54 to a compact disk 40. The edges 14 of the backing or carrier layer 11 are peeled or removed 55 to expose the adhesive 15 on the rear surface 22 of the label layer 20.

The compact disk label apparatus 10 is then folded 56 along the perforation 16 or fold 16 so that the apparatus 10 folds onto itself, allowing the edges 14 of the label layer 20 to adhere together or to adhere to the backing or carrier layer 11. This forms a compact disk sleeve 35 having an open end into which the labeled compact disk 40 (or unlabeled disk) may be placed.

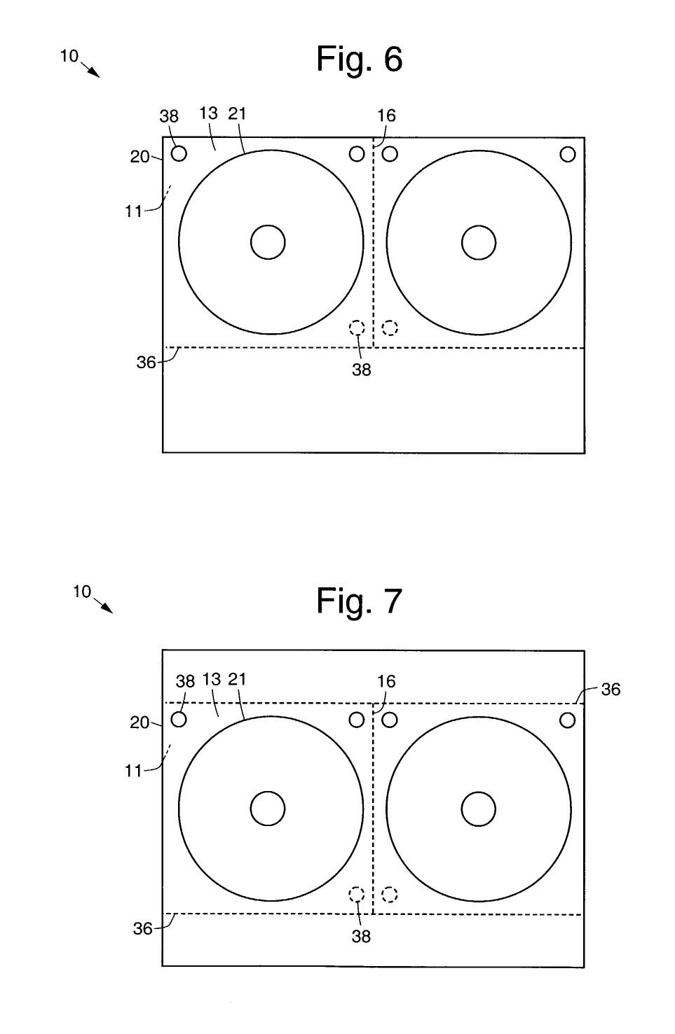

FIGS. 6 and 7 illustrate alternative embodiments of the compact disk labeling apparatus 10. The alternative embodiments of the compact disk labeling apparatus 10 shown in FIGS. 6 and 7 are part of a larger original sheet. In the embodiment shown in FIG. 6, the compact disk labeling apparatus 10 is formed on one side of an 8.5 inch by 11 inch sheet of material comprising the backing layer 11 and the label layer 20. A perforation 36 is provided in this embodiment that allows removal of excess material to produce the compact disk sleeve 35. In the embodiment shown in FIG. 7, the compact disk labeling apparatus 10 is formed substantially in the middle of an 8.5 inch by 11 inch sheet of material comprising the backing layer 11 and the label layer 20. Two perforations 36 are provided in this embodiment that allows removal of excess material to produce the compact disk sleeve 35. FIGS. 6 and 7 also illustrate that punched holes 38 may be provided through the compact disk labeling apparatus 10 that, when folded, allow the compact disk sleeve 35 to be stored in a ring-type binder. The punched holes 38 may be formed along any of the edges of the compact disk labeling apparatus 10 as illustrated in FIGS. 6 and 7.

Thus, compact disk label apparatus for use with a compact disk that is configurable as a compact disk sleeve and method of making same have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Compact disk label apparatus comprising:
a backing layer having front and rear surfaces and having a plurality of removable edges;
an adhesive-backed label layer disposed on the front surface of the backing layer that comprises an adhesive-backed compact disk label; and
a fold formed across the compact disk label apparatus that allows it to be folded onto itself to seal the edges when the edges are removed to form a sleeve having an open end.

2. The apparatus recited in claim 1 wherein the fold comprises a perforation.

3. The apparatus recited in claim 1 further comprising a folding tab portion that extends from the backing layer that may be folded over the open end of the sleeve to fully enclose it.

4. The apparatus recited in claim 2 further comprising a folding tab portion that extends from the backing layer that may be folded over the open end of the sleeve to fully enclose it.

5. Compact disk label apparatus comprising:
a backing layer having front and rear surfaces and having a plurality of removable edges;
an adhesive-backed label layer disposed on the front surface of the backing layer that comprises an adhesive-backed compact disk label; and
a perforation formed across the compact disk label apparatus that allows it to be folded onto itself to seal the edges when the edges are removed to form a sleeve having an open end.

6. The apparatus recited in claim 5 further comprising a folding tab portion that extends from the backing layer that may be folded over the open end of the sleeve to fully enclose it.

7. The apparatus recited in claim 5 further comprising a folding tab portion that extends from the backing layer that may be folded over the open end of the sleeve to fully enclose it.

8. A method of forming a compact disk sleeve comprising the steps of:
providing compact disk label apparatus comprising a backing layer having a plurality of removable edges, an adhesive-backed label layer comprising a removable adhesive-backed compact disk label disposed adjacent to the backing layer, and a fold that allows the apparatus to fold onto itself;
printing onto the compact disk label using software running on a computer;
removing the printed compact disk label from contact with the backing layer;
removing the edges of the backing layer to expose the adhesive adjacent the edges of the label layer; and
folding the compact disk label apparatus along the fold so that it adhesively secures together along its edges to form a compact disk sleeve having an open end.

9. The method recited in claim 8 further comprising the step of attaching the printed compact disk label onto a compact disk.

10. The method recited in claim 8 wherein the fold comprises a perforation.
